(19) United States
(12) Patent Application Publication
(10) Pub. No.: US 2012/0054668 A1
(43) Pub. Date: Mar. 1, 2012

(54) CONTENT DISPLAY METHOD AND APPARATUS

(75) Inventors: Young-Joon Ahn, Yongin-si (KR); Jeong-Hun Park, Yongin-si (KR); Yang-Ju Lee, Seoul (KR)

(73) Assignee: SAMSUNG ELECTRONICS CO., LTD., Suwon-si (KR)

(21) Appl. No.: 13/217,079

(22) Filed: Aug. 24, 2011

(30) Foreign Application Priority Data
Aug. 27, 2010 (KR) 10-2010-0083704

(51) Int. Cl. G06F 3/048; G09G 5/377

(52) U.S. Cl. 715/781; 345/629

(57) ABSTRACT

A content display method and apparatus. The content display method includes displaying a group, generated by grouping contents, including location information and time information, according to a local criterion based on the location information of the contents, on a map, and providing an interface which displays the contents of the group according to a temporal criterion based on the time information of the contents of the group.

### CROSS-REFERENCE TO RELATED APPLICATION(S) AND CLAIM OF PRIORITY

The present application is related to and claims the benefit of Korean Patent Application No. 10-2010-0083704, filed on Aug. 27, 2010, in the Korean Intellectual Property Office, the disclosure of which is incorporated herein in its entirety by reference.

### TECHNICAL FIELD OF THE DISCLOSURE

The present disclosure generally relates to displays, and more particularly, to a content display method and apparatus.

### BACKGROUND OF THE DISCLOSURE

Currently, most devices, when displaying digital content, arrange the digital content by separately using its time information or space information, and use the time information or the space information for viewing or searching the digital content. For example, a device may arrange and display images according to a time sequence of generation, or may simply indicate a location where a picture is associated with a map to inform a user of the location of the picture.

The user, when searching for content by using the device, may search for content generated or collected by the user based on a time or a location memorized by the user. In this case, a search may take a relatively long time due to limited search conditions.

### SUMMARY OF THE DISCLOSURE

To address the above-discussed deficiencies of the prior art, it is a primary object to provide a content display method and apparatus for displaying content on a map by using space information of the content and displaying the content on a region other than the map by using time information of the content.

According to a first embodiment, a content display method includes displaying a first group on a map, the first group being generated by grouping contents, including location information and time information, according to a local criterion based on the location information of the contents, and providing an interface which displays contents of the first group according to a temporal criterion based on time information of the contents of the first group.

According to a particular embodiment, displaying the contents of the first group may include displaying a second group generated by grouping the contents of the first group according to a temporal criterion and providing an interface which displays contents of the second group. According to another particular embodiment, displaying the contents of the second group may include providing the interface which displays the contents of the second group according to a time sequence. According to another particular embodiment, displaying the contents of the first group may include displaying a third group, generated by grouping the contents of the first group according to a temporal criterion and subordinate groups of the first group, and providing an interface which displays contents of the third group, in which the subordinate groups of the first group are generated by grouping according to a smaller local criterion than the local criterion used for the first group.

According to another particular embodiment, the content display method may further include, upon receiving a selection signal with respect to the displayed first group, scaling up the map based on the local criterion for the first group. According to another particular embodiment, the content display method may further include, if a temporal range is set, deactivating or not displaying contents which are beyond the temporal range among the contents of the first group. According to another particular embodiment, the content display method may further include, if a temporal range is set and all of the contents of the displayed first group are beyond the temporal range, deactivating or not displaying the first group. According to another particular embodiment, the content display method may further include providing an interface which provides time information of the group or the contents in the form of a bar. According to another particular embodiment, the content display method may further include setting a temporal range by changing the time information displayed in the form of a bar on the interface.

According to a second embodiment, a content display method includes displaying a group and contents of the group, the group being generated by grouping contents, including location information and time information, according to at least one of a local criterion and a temporal criterion, and upon receiving a selection signal with respect to the group or the contents, and displaying the selected group or contents on a map based on the local criterion used for the selected group or the location information of the selected contents.

According to a third embodiment, a content display method includes displaying a group generated by grouping contents, including location information and time information, according to a local criterion and a temporal criterion, and display regions of the group according to a local distribution of the contents of the group on a map.

According to a fourth embodiments, a display content apparatus includes a display unit and an interface configured to display a group, generated by grouping contents, including location information and time information, according to a local criterion based on the location information of the contents, on a map displayed on the display unit, and display the contents of the group on a non-map region of the display unit according to a temporal criterion.

According to a fifth embodiment, a display content apparatus includes a display unit and an interface configured to display a group, generated by grouping contents, including location information and time information, according to at least one of a local criterion and a temporal criterion, and contents of the group on the display unit, and upon receiving a selection signal with respect to the group or the contents, display the selected group or contents on the map of the display unit based on the local criterion used for the selected group or the location information of the selected contents.

According to a sixth embodiment, a display content apparatus includes a display unit and an interface configured to display a group, generated by grouping contents, including location information and time information, according to at least one of a local criterion and a temporal criterion on a map of the display unit, and display regions of the group according to a local distribution of the contents of the group on the map.

According to seventh embodiment, there is provided a computer-readable recording medium having recorded thereon a program for executing a content display method. The content display method includes displaying a first group on a map, the first group being generated by grouping contents, including location information and time information, according to a local criterion based on the location information of the contents, and providing an interface which displays contents of the first group according to a temporal criterion based on time information of the contents of the first group.

According to an eighth embodiment, there is provided a computer-readable recording medium having recorded thereon a program for executing a content display method. The content display method includes displaying a group and contents of the group, the group being generated by grouping contents, including location information and time information, according to at least one of a local criterion and a temporal criterion, and upon receiving a selection signal with respect to the group or the contents, displaying the selected group or contents on a map based on the local criterion used for the selected group or the location information of the selected contents.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts: The above and other features and advantages of the present invention will become more apparent by describing in detail exemplary embodiments thereof with reference to the attached drawings in which:

FIG. 1 illustrates a content display method according to this disclosure;

FIG. 2 illustrates a structure of generated groups according to this disclosure;

FIG. 3 illustrates an example display that may be generated according to the content display method shown in FIG. 1;

FIG. 4 illustrates a content display method according to this disclosure;

FIG. 5 illustrates an example display that may be generated according to the content display method shown in FIG. 4;

FIG. 6 illustrates a flowchart of a content display method according to this disclosure;

FIGS. 7 and 8A through 8C illustrates an example of the content display method shown in FIG. 6; and

FIG. 9 illustrates a content display apparatus according to this disclosure.

### DETAILED DESCRIPTION OF THE INVENTION

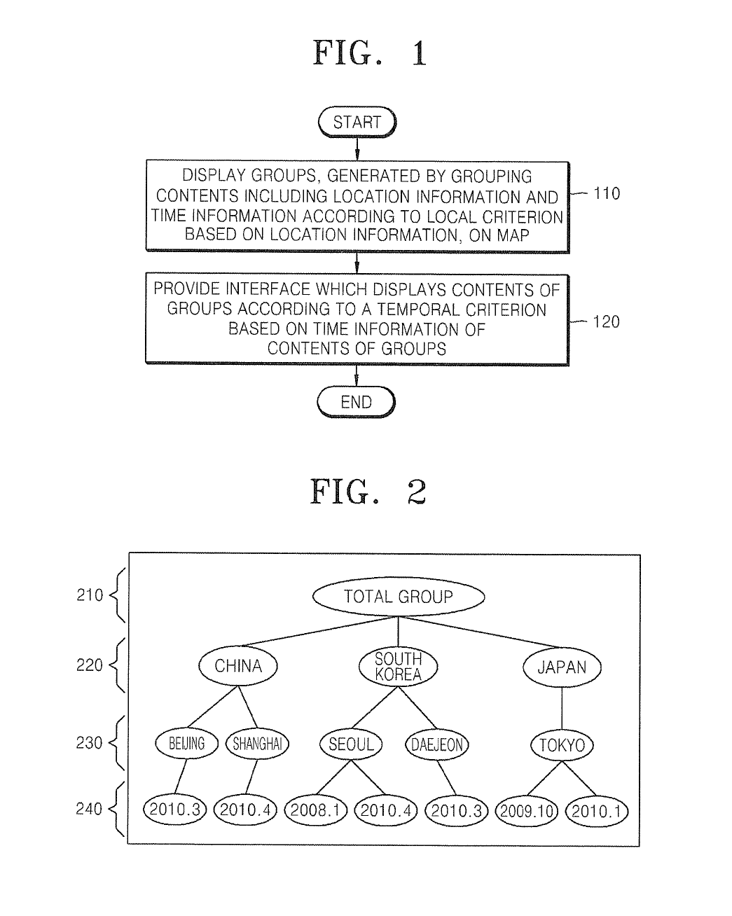

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged computing systems arranged with displays.

In certain embodiments according to the present disclosure, content may generally refer to content that includes additional information, such as location information and time information. For example, content may be construed to mean a still image or a moving image which includes location information such as Global Positioning System (GPS) information and time information such as a date of acquisition.

FIG. 1 illustrates a content display method according to this disclosure. In operation 110, a content display apparatus displays groups on a map, in which the groups are generated by grouping contents, including location information and time information, according to a local criterion based on the location information of the contents.

The contents may be grouped according to position criterion based on their location information. For example, content may be grouped according to country, such as South Korea, China, Japan, etc. based on location information associated with the content. In some embodiments, the content display apparatus may group content stored or received from an external source before displaying these groups on a map. In other embodiments, the content display apparatus may display groups, which have already been grouped and stored by a user, on the map.

In operation 120, the content display apparatus provides an interface which displays contents of the groups displayed on the map according to a temporal criterion based on time information of the contents of the groups. The content display apparatus generates groups by grouping the contents of the groups displayed on the map according to the temporal criterion, and displays the generated groups on a region other than the map, for instance, a non-map region. The content display apparatus may also display contents of the groups that have been generated according to the temporal criterion. If a group displayed on the map is the most subordinate group, the content display apparatus may display contents of the displayed group on a non-map region without grouping the contents according to the temporal criterion. The content display apparatus may also generate groups by grouping contents according to time information of the contents of the displayed group and its subordinate groups, and may display the generated groups and contents included in the generated groups on the non-map region.

FIG. 2 illustrates an example structure of groups according to this disclosure. As shown, the groups are arranged in a tree structure. A total group 210, which may be somewhat similar to a root directory of a computer file system, includes all contents. Subordinate groups are generated according to a spatial or temporal criterion based on location information and time information of contents of their respective superordinate group. For example, groups 220 generated by grouping contents according to a country, such as China, South Korea, or Japan, are set as subordinate groups of the total group 210, and groups 230 generated by grouping contents according to a city, such as Beijing or Shanghai in China, Seoul or Daejeon in South Korea, or Tokyo in Japan, which is generally smaller than a country, may be arranged as subordinate groups 230 of groups 220. The groups 220 and 230 are generated by grouping contents according to local criteria based on location information of the contents.

When a user selects a group that is displayed on a map, the content display apparatus, by referring to a local criterion of the selected group, scales up (or enlarges) the map according to the referred local criterion, and displays subordinate groups of the selected group on the map. For example, if the user selects a group corresponding to South Korea, the map is scaled up to display South Korea and its subordinate groups for display on the map.

Certain groups may include subordinate groups generated according to temporal criteria. As shown, the city-related groups 230 may have subordinates groups 240 representing temporal criteria associated with the city-related groups 230. Groups generated according to the temporal criterion and the contents of the groups may be arranged according to a time sequence.

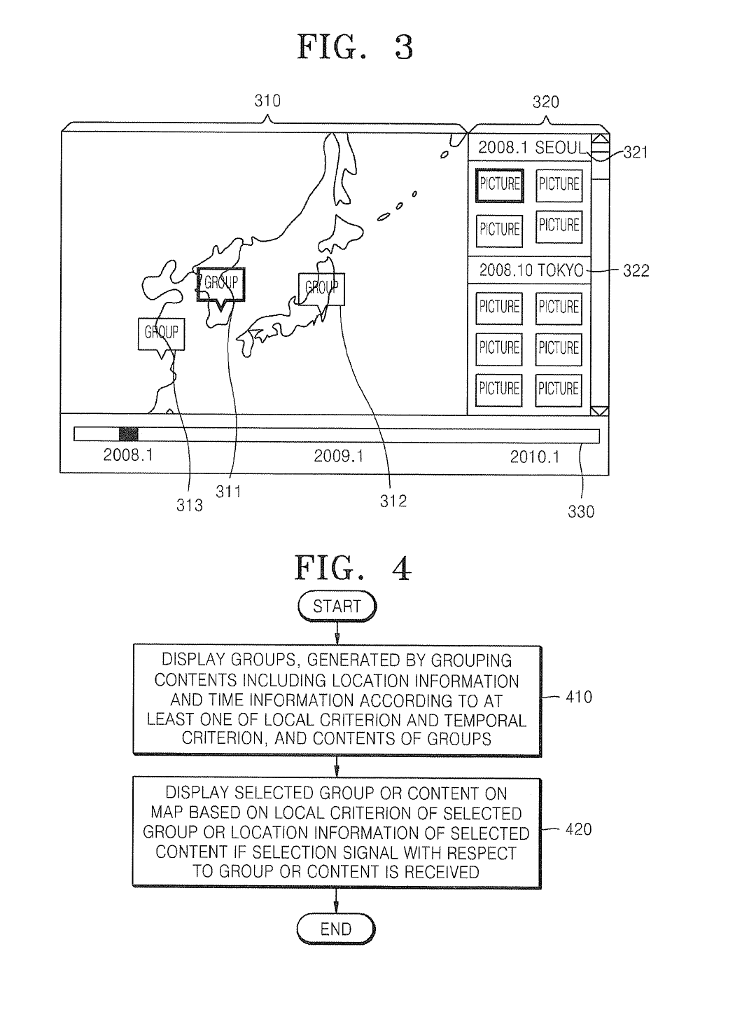

FIG. 3 illustrates an example display that may be generated according to the content display method shown in FIG. 1. As shown, the display displays groups 311, 312, and 313 generated according to a local criterion on a map region 310. Groups 321 and 322 generated by grouping contents of the groups 311, 312, and 313 according to a temporal criterion and their subordinate groups, along with contents of the groups 321 and 322 are displayed on a non-map region 320. That is, the country-related groups 311, 312, and 313 generated according to a country such as South Korea, China, or Japan are displayed on the map region 310, while the groups 321 and 322, generated by grouping contents of the country-related groups 311, 312, and 313 that are displayed on the map region 310 according to a temporal criterion such as January 2008 or October 2009 and subordinate groups according to city such as Seoul or Tokyo, are displayed on the non-map region 320.

The content display apparatus may provide an indicator indicating time information of a group or content. In one embodiment, the content display apparatus provides an interface in the form of a bar 330 on which time information is displayed. The bar shows time information of a selected or focused group or an indicator. When the user sets a particular time on the bar 330 and there is a group having all contents beyond a range of the set time among groups displayed on the map 310, the group may be deactivated or may not be seen on the map. A group and contents which are beyond a range of the set time on a non-map region 320 may also be deactivated or invisible.

If the user focuses contents on the non-map region or sets a time by using the bar, a map may be displayed as long as the map of a corresponding time exists.

The contents of the groups 321 and 322 are also displayed on the non-map region 320. An interface 330 in the form of a bar is also provided to indicate time information of a group or content.

In another embodiment, the content display apparatus may display subordinate groups of a group displayed on the map among groups that are grouped in advance according to location information and time information, and contents of the subordinate groups on the non-map region.

FIG. 4 illustrates and example content display method according to this disclosure. In operation 410, the content display apparatus displays groups, generated by grouping contents, including location information and time information, according to at least one of a local criterion, a temporal criterion, and contents of the groups. For example, the content display apparatus may group contents according to a local criterion, such as Seoul or Tokyo, and display corresponding contents according to a temporal criterion, such as January 2008 or October 2009. As another example, the content display apparatus may group contents according to both a local criterion and a temporal criterion such as Seoul in January 2008 or Tokyo in October 2009 and display their corresponding contents. The content display apparatus may label groups or leave a space between the groups, so that the groups may be distinguished from each other. Grouping of contents is the same as described with respect to FIG. 2, and thus, is not described in detail.

In operation 420, the content display apparatus, upon receiving a selection signal with respect to a group or content, displays the selected group or content in a corresponding location on a map based on a local criterion of the selected group or location information of the selected content. If the user selects or focuses a displayed group, the content display apparatus displays the group in a corresponding location on the map according to the local criterion used for generation of the selected or focused group. In this case, the content display apparatus may display contents included in the group in a corresponding location on the map according to location information of the contents. If the user selects or focuses on certain displayed content, the content display apparatus may display a group in a corresponding location on the map according to location information of the content. If the local criterion of the selected group or the location information of the content does not correspond to the current map, the content display apparatus may scale up, scale down, or shift the map.

The content display apparatus may also provide an indicator indicating time information of a group or content. In one embodiment, the content display apparatus provides an interface in the form of a bar in which the time information is displayed. The bar shows time information of a selected or focused group. If the user sets a particular time on the bar, a group or content corresponding to the set time is displayed on the map.

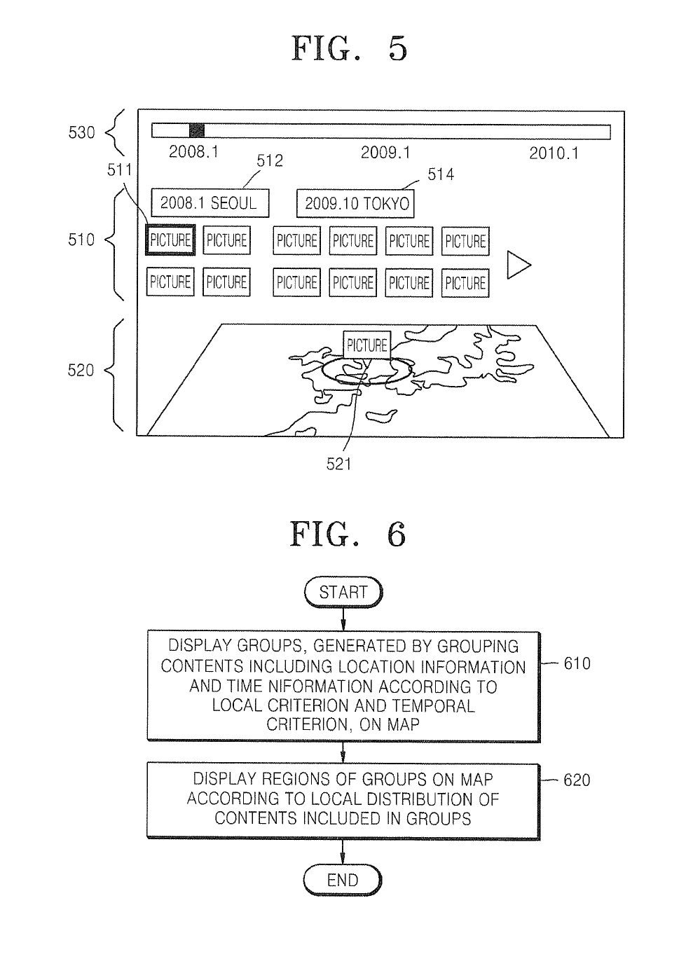

FIG. 5 illustrates an example display that may be generated according to the content display method shown in FIG. 4. A region 510 includes groups that are displayed according to their grouping contents, including location information and time information, according to at least one of a local criterion and a temporal criterion and the contents of the groups. For example, groups generated by grouping contents according to both a local criterion and a temporal criterion, such as a “2008-1-Seoul” group 512 or a “2009-10-Tokyo” group 514, are displayed. The groups are labeled as shown in FIG. 5, and a space is left between the groups to distinguish one from another. Under the “2008-1-Seoul” and “2009-10-Tokyo” groups 512 and 514 are displayed their corresponding contents. When the user selects or focuses content 511 from the “2008-1-Seoul” group 512, the selected content 511 is displayed in a corresponding location on a map 520 based on location information of the selected content 511. If the user selects a group, the selected group is displayed on the map 520.

An indicator indicating time information of a group or content may be provided. In one embodiment, an interface 530 in the form of a bar on which time information is displayed may be provided as the indicator. The interface 530 in the form of a bar shows time information of a selected or focused group or an indicator. If the user sets a particular time by using the interface 530 in the form of a bar, a group or content corresponding to the set time is displayed on the map 520.

FIG. 6 illustrates an example content display method according to this disclosure. In operation 610, the content display apparatus displays groups, generated by grouping contents, including location information and time information, according to a local criterion and a temporal criterion, on a map. For example, the content display apparatus may generate groups by grouping contents according to both a local criterion and a temporal criterion, such as Jeju-do in 2008 or the eastern part of Jeju-do in 2010, and may display the generated groups on the map.

In operation 620, the content display apparatus displays regions of the groups on the map according to the local distribution of contents included in the groups. The range of the local distribution may be adjusted according to a user's setting. For example, the user may set an option for a criterion of the local distribution in units of “do(province/state)”, “si(city)”, “gun(county)”, “eup(town)”, “myeon(township)”, or “ri(village)” as an administrative district. When the option is set for the administrative district, a distribution region may be displayed for the administrative district. For example, if a local criterion of a group is “Jeju-do” and the local distribution of contents included in the group is large in “Jeju-do”, the user may set the local distribution of the contents as “Jeju-si”, such that only regions corresponding to “Jeju-si” may be displayed on the map. In this case, the user may adjust a content distribution region, thus quickly searching for desired content in detail. Regions of groups may overlap on the map. In this case, contents generated with a time difference between different groups in the same region may be distinguished.

When the user selects a region of a group that is displayed on the map, contents included in the selected region may be displayed on a non-map region. When the user selects displayed content, the selected content may be displayed in a corresponding location on the map. If the user selects an overlapping region, content included in the overlapping region may be displayed on the non-map region.

The user may group contents by changing a local criterion and a temporal criterion and display corresponding groups. Alternatively, the user may select a desired group from among a plurality of generated groups.

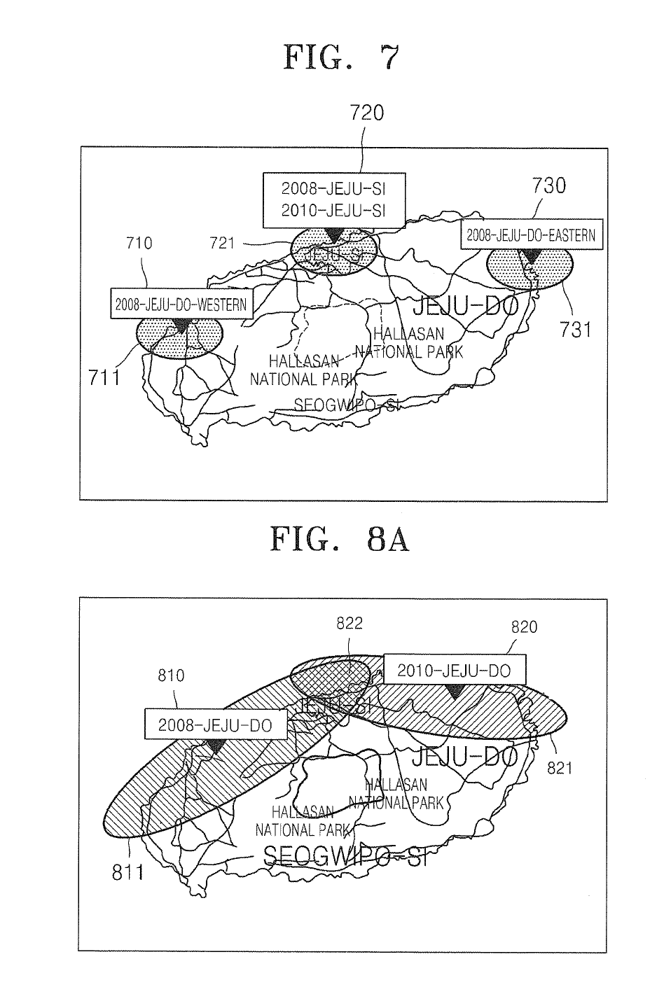

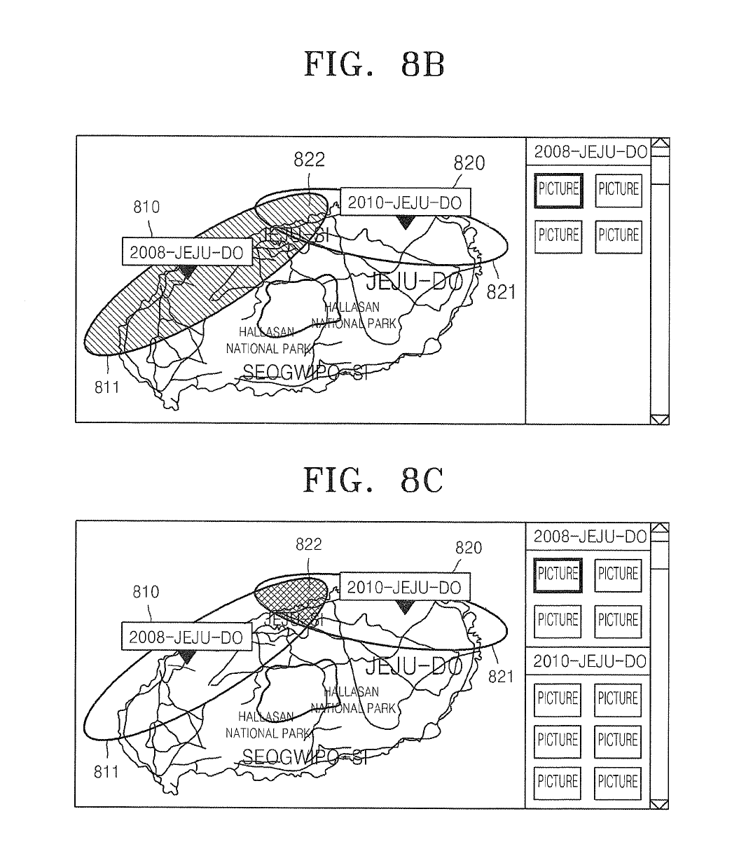

FIGS. 7 and 8A through 8C illustrate an example of the content display method shown in FIG. 6.

Referring to FIG. 7, a “2008-Jeju-do-western” group 710, a “2008-Jeju-si/2010-Jeju-si” group 720, and a “2010-Jeju-do-eastern” group 730 are displayed on the map, and regions 711, 721, and 731 according to distributions of contents of the groups are displayed on the map.

Referring to FIG. 8A, when the user groups the contents to generate a “2008-Jeju-do” group 810 and a “2010-Jeju-do” group 820 or selects “2008-Jeju-do” and “2010-Jeju-do” groups 810 and 820, “2008-Jeju-do” and “2010-Jeju-do” groups 810 and 820 are displayed on the map. Content distribution regions 811 and 821 of “2008-Jeju-do” and “2010-Jeju-do” groups 810 and 820 are displayed on the map and an overlapping region 822 may also be displayed on the map. In this case, the overlapping region 822 is distinctively displayed with a color different from the content distribution regions 811 and 821.

Referring to FIG. 8B, the user selects the “2008-Jeju-do” group 810, such that contents corresponding to the “2008-Jeju-do” group 810 are displayed.

Referring to FIG. 8C, the user selects the overlapping region 822, such that contents corresponding to both the “2008-Jeju-do” group 810 and the “2010-Jeju-do” group 820 are displayed.

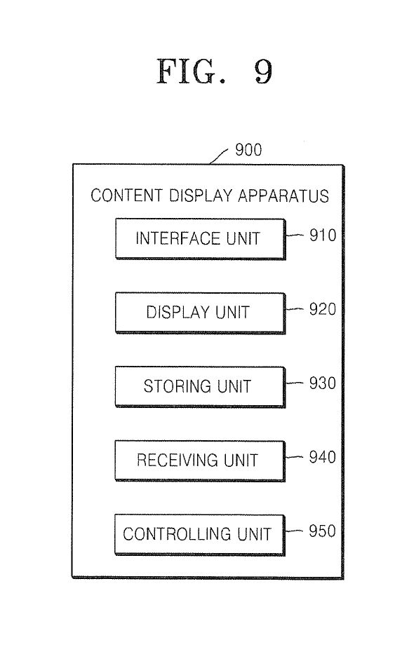

FIG. 9 illustrates an example content display apparatus 900 according to this disclosure. The content display apparatus 900 includes an interface unit 910, a display unit 920, a storing unit 930, a receiving unit 940, and a controlling unit 950. The interface unit 910 displays groups, generated according to a local criterion based on location information of contents including the location information and time information, on a map that may be displayed on the display unit 920. The interface unit 910 displays groups stored in the storing unit 950 on the map according to location information or local criteria of the groups. The interface unit 910 may also display groups generated by grouping contents received through the receiving unit 940 or/and contents stored in the storing unit 950 by the controlling unit 950 on the map according to location information or local criteria of the groups. The groups and their relation to one another may be associated with each other as described above with respect to FIG. 2.

When the user selects a group to be displayed on the map, the interface unit 910, by referring to a local criterion of the selected group, increases the scale of the map according to the referred local criterion and displays subordinate groups of the selected group on the map. For example, if the user selects a group corresponding to South Korea, the interface unit 910 increases the scale of the map to show South Korea and displays subordinate groups of the group corresponding to South Korea on the map.

The interface unit 910 provides an interface which displays contents of the group displayed on the map according to the temporal criterion, based on time information of the contents of the group displayed on the map of the display unit 920.

The controlling unit 950 groups the contents of the group displayed on the map of the display unit 920 according to the temporal criterion. The controlling unit 950 may group the contents of the group displayed on the map, according to the time information of the contents and the subordinate groups of the group displayed on the map.

The interface unit 910 may display the contents included in the group generated by the controlling unit 950 on a non-map region, and displays both the group and its contents on the non-map region. In this case, the interface unit 910 may arrange the group and/or its contents according to a time sequence. If the group displayed on the map is the most subordinate group, the interface unit 910 may display the contents of the displayed group on the non-map region, without grouping the contents according to the temporal criterion.

The interface unit 910 may also provide the indicator indicating time information of the group or contents on a region other than a region which displays the map and contents. In one embodiment, the interface unit 910 provides an interface in the form of a bar on which time information is displayed. The bar shows time information of a selected or focused group or the indicator. When the user sets a particular time on the bar, the controlling unit 950 searches for a group or contents which may be beyond a range of the set time among groups displayed on the map. The interface unit 910 deactivates the group that is found or its contents, or makes them invisible on the map. The group that is found is a group having all contents beyond the range of the set time.

When the user focuses contents on the non-map region or sets a time by using the bar, the interface unit 910 may display a map corresponding to the set time if such a map exists. In another embodiment, the interface unit 910 may display subordinate groups of the group displayed on the map among groups previously generated according to location information and time information, and contents of the group on the non-map region.

In another embodiment, the controlling unit 950 may group contents according to a local criterion, such as Seoul or Tokyo, according to a temporal criterion such as “January 2008” or “October 2009”, or according to both a local criterion and a temporal criterion such as Seoul in “January 2008” or Tokyo in “October 2009.” Groups generated by the controlling unit 950 are stored in the storing unit 930. The groups, which have already been generated, instead of being generated by the controlling unit 950, may be received by the receiving unit 940 and then stored in the storing unit 930.

The interface unit 910 displays the groups stored in the storing unit 930 and contents of the groups on the display unit 920. The interface unit 910 may label the groups or leave a space between the groups to distinguishably display the groups.

When the receiving unit 940 receives a selection signal with respect to a group or content from the user, the interface unit 910 displays the selected group or content in a corresponding location on a map based on a local criterion of the selected group or location information of the selected content. If the local criterion of the selected group or the location information of the selected content does not correspond to the current map, the interface unit 910 may scale up, scale down, or shift the map.

The interface unit 910 may provide an indicator indicating time information of a group or content. In one embodiment, the interface unit 910 provides an interface in the form of a bar in which the time information is displayed. The bar shows time information of a selected or focused group or the indicator. When the user sets a particular time on the bar, the interface unit 910 displays a group or content corresponding to the set time.

In another embodiment, the controlling unit 950 generates groups by grouping contents, including location information and time information, according to a local criterion and a temporal criterion. For example, the controlling unit 950 may generate groups by grouping contents according to both a local criterion and a temporal criterion such as “Jeju-si in 2008” or the “eastern part of Jeju-do in 2010.” The groups generated by the controlling unit 950 are stored in the storing unit 930. The groups, which have already been generated, instead of being generated by the controlling unit 950, may be received by the receiving unit 940 and then stored in the storing unit 930.

The interface unit 910 may display a region of a group on a map according to a local distribution of the group and contents included in the group. The range of the local distribution may be adjusted according to a user's setting. The user may set an option for a criterion of the local distribution in units of “do(province/state)”, “si(city)”, “gun(county)”, “eup(town)”, “myeon(township)”, or “ri(village)” as an administrative district. When the option is set for the administrative district, the interface unit 910 may display a distribution region for the administrative district. Regions of groups may overlap on the map.

In this case, contents generated with a time difference between different contents in the same region may be distinguished. When the user selects an overlapping region, the interface unit 910 displays contents included in the overlapping region.

The user may generate and display groups of contents by changing a local criterion and a temporal criterion. The user may also select a desired group from among a plurality of generated groups.

The content display method according to the present invention may be embodied as a computer-readable code on a computer-readable recording medium. The recording medium may be all kinds of recording devices storing data that is readable by a computer. Examples of the recording medium include read-only memory (ROM), random access memory (RAM), CD-ROMs, magnetic tapes, floppy disks, and optical data storage devices. The computer-readable recording medium can also be distributed over a network of coupled computer systems so that the computer-readable code is stored and executed in a decentralized fashion. Function programs, code, and code segments for implementing the content display method may be easily derived by programmers of ordinary skill in the art.

Accordingly, the disclosed embodiments should be considered in an illustrative sense not in a limiting sense. The scope of the present disclosure is defined not by the detailed description of the present disclosure but by the appended claims, and all differences within the scope will be construed as being included in the present disclosure. Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A content display method comprising:
displaying a first group on a map, the first group being generated by grouping contents comprising location information and time information according to a local criterion based on the location information of the contents; and
providing an interface which displays contents of the first group according to a temporal criterion based on time information of the contents of the first group.

2. The content display method of claim 1, wherein the providing of the interface which displays the contents of the first group comprises:
displaying a second group generated by grouping the contents of the first group according to a temporal criterion; and
providing an interface which displays contents of the second group.

3. The content display method of claim 2, wherein the providing of the interface which displays the contents of the second group comprises providing the interface which displays the contents of the second group according to a time sequence.

4. The content display method of claim 1, wherein the providing of the interface which displays the contents of the first group comprises:
displaying a third group, generated by grouping the contents of the first group according to a temporal criterion and subordinate groups of the first group; and
providing an interface which displays contents of the third group;
wherein the subordinate groups of the first group are generated by grouping the subordinate groups according to a smaller local criterion than the local criterion used for the first group.

5. The content display method of claim 1, further comprising, upon receiving a selection signal with respect to the displayed first group, increasing the scale of the map based on the local criterion for the first group.

6. The content display method of claim 1, further comprising, if a temporal range is set, deactivating or not displaying contents which are beyond the temporal range among the contents of the first group.

7. The content display method of claim 1, further comprising, if a temporal range is set and all of the contents of the displayed first group are beyond the temporal range, deactivating or not displaying the first group.

8. The content display method of claim 1, further comprising providing an interface which provides time information of the group or the contents using a bar.

9. The content display method of claim 8, further comprising setting a temporal range by changing the time information displayed using the bar on the interface.

10. A content display method comprising:
displaying a group and contents of the group, the group being generated by grouping contents comprising location information and time information according to at least one of a local criterion and a temporal criterion; and
upon receiving a selection signal with respect to the group or the contents, displaying the selected group or contents on a map based on the local criterion used for the selected group or the location information of the selected contents.

11. The content display method of claim 10, further comprising, upon receiving a selection signal with respect to the group, increasing or decreasing the scale of the map which displays the group based on the local criterion used for the selected group.

12. The content display method of claim 10, further comprising, upon receiving the selection signal with respect to the group or the contents, providing an interface which provides the temporal criterion used for the selected group or the time information of the selected contents using a bar.

13. The content display method of claim 12, further comprising, if changing time information of the interface provided using the bar, displaying contents of a group corresponding to the changed time information on the map.

14. A content display method comprising:
displaying a group generated by grouping contents comprising location information and time information according to a local criterion and a temporal criterion; and
displaying regions of the group according to a local distribution of the contents of the group on a map.

15. The content display method of claim 14, wherein the local criterion and the temporal criterion are changeable according to a user's selection.

16. A display content apparatus comprising:
a display unit; and
an interface operable to:
display a group, generated by grouping contents comprising location information and time information according to a local criterion based on the location information of the contents, on a map displayed on the display unit; and
display the contents of the group on a non-map region of the display unit according to a temporal criterion.

17. A display content apparatus comprising:
a display unit; and
an interface operable to:
display a group, generated by grouping contents comprising location information and time information according to at least one of a local criterion and a temporal criterion, and contents of the group on the display unit; and
upon receiving a selection signal with respect to the group or the contents, display the selected group or contents on the map of the display unit based on the local criterion used for the selected group or the location information of the selected contents.

18. A display content apparatus comprising:
a display unit; and
an interface operable to:
display a group, generated by grouping contents comprising location information and time information according to at least one of a local criterion and a temporal criterion on a map of the display unit; and
display regions of the group according to a local distribution of the contents of the group on the map.

19. A computer-readable recording medium having recorded thereon a program for executing a content display method, the content display method comprising:
displaying a first group on a map, the first group being generated by grouping contents comprising location information and time information according to a local criterion based on the location information of the contents; and
providing an interface which displays contents of the first group according to a temporal criterion based on time information of the contents of the first group.

20. A computer-readable recording medium having recorded thereon a program for executing a content display method, the content display method comprising:
displaying a group and contents of the group, the group being generated by grouping contents comprising location information and time information according to at least one of a local criterion and a temporal criterion; and
upon receiving a selection signal with respect to the group or the contents, displaying the selected group or contents on a map based on the local criterion used for the selected group or the location information of the selected contents.
